(19) United States
(12) Patent Application Publication
(10) Pub. No.: US 2023/0008504 A1
(43) Pub. Date: Jan. 12, 2023

(54) System and Method for Gamified Social Media

(71) Applicant: Bert Pope, Tallahassee, FL (US)

(72) Inventor: Bert Pope, Tallahassee, FL (US)

(21) Appl. No.: 17/861,331

(22) Filed: Jul. 11, 2022

Related U.S. Application Data
(60) Provisional application No. 63/220,059, filed on Jul. 9, 2021.

(51) Int. Cl. G06Q 50/00; G06Q 20/36; G06Q 40/04; G06Q 30/02

(52) U.S. Cl. CPC G06Q 50/01; G06Q 20/36; G06Q 40/04; G06Q 30/0279; G06Q 30/0209

(57) ABSTRACT

A social media platform incorporating game functions and positivity. Users accumulate points as they engage in positivity by sharing content through gif files, links, videos, photos, and text. The user may work his or her way up to different levels based on points earned. A leader board displays the top earning users, furthering competition to engage in positivity. Virtual badges may be accumulated. Challenge videos and positive video clips are aggregated and voted on by awarding Kindness Koins® for charity. A flagging ability allows a user to delete another user's post. If enough user's delete a post, it disappears from the platform. Users are prompted to re-think posts including with flagrant messages.

### CROSS-REFERENCES TO RELATED APPLICATIONS

Pursuant to the provisions of 37 C.F.R. § 119(e), this non-provisional application claims the benefit of an earlier-filed provisional patent application. The earlier application was assigned Ser. No. 63/220,059. It lists the same inventor.

### STATEMENT REGARDING FEDERALLY SPONSORED RESEARCH OR DEVELOPMENT

Not Applicable

### MICROFICHE APPENDIX

Not Applicable

### BACKGROUND

### 1. Field of the Invention

This invention relates to the field of method and systems for gamification. Specifically, the invention relates to a system and method for incorporating gaming rewarding positive behavior with social media.

### 2. Description of the Related Art

Social media websites are very common and ordinary in today's world. Typically, social media is used to connect with friends and express one's feelings, share pictures and text posts, and stay up to date with others. FIG. 1 illustrates a current social media platform. The prior art social media website or mobile application user interface 10 includes a news feed 12. Typically, a user 14 has an accepted group of friends who can view and comment on the user's profile or news feed 12. The user 14 can share comments, videos, links and photos he or she finds of interest, as well as comment on another user's content. However, social media websites themselves typically do not incorporate gaming into their platforms. Further, since social media websites offer a means for people to express their views and opinions, there is a high likelihood for debate, disagreements, false information and negative discourse that can occur on the social media website. This environment can lead to discouraging, argumentative, combative, and even threatening behavior on the internet, which children and young adults are especially susceptible to. For example, when one user posts a message 16 in the news feed 12 relating to supporting a cause, another user may comment on that news feed in a negative manner 18. There is no discouragement to posting negative comments and more importantly, there is no incentive for being kind and positive.

Additionally, there are various online platforms or apps that use algorithms to display video clips to users, such as TikTok® and Instagram®. These algorithms feed directed content to a user, but there is no mechanism in place to exclude negative content or aggregate positive content.

For the foregoing reasons, there is a need for a social media platform that engages its users in positivity and kindness while diminishing or eliminating negative interactions through gamification. The present system and method solves these problems by encouraging positive interaction with others both online and in everyday life and allowing for the aggregation and upvoting (judging) of positive kid-friendly content. The method does so by rewarding and incentivizing kind and helpful behavior, along with allowing users to provide feedback and direct contributions relating to positive content (e.g. video clips). The method may also have a flagging feature, prompting its user to re-think flagrant behavior such as swearing, degrading or negative comments prior to formally posting them to the platform.

### SUMMARY

The present method is directed to a gamified social media platform which focuses on positivity and its overall beneficial effect on others. Users will use the present system and method to judge (upvote) and share content including image or gif files, links, videos, photos, and text to engage in positivity. The user will earn points as he or she engages in positive actions. As points accumulate, the user may “level up,” which may include a glowing ring around the user's profile picture on the social media platform. There may also be a leader board, which displays the top users, as well as virtual badges which a user may earn as he or she engages in positive behavior.

Challenges can be created to encourage positive behavior. These challenges may include, for example, doing positive acts for society and humanity. A user can earn points by creating, sharing, or participating in the challenges. Additionally, tokens and/or digital coins may be incorporated into the platform, which may be shared amongst users and can be earned or purchased. The tokens may be used for gifts, coupons, discounts, or the like from companies, incentivizing positive behavior even further. Additionally, digital coins, which would represent a fraction of a dollar, can be purchased, gifted, earned, or donated to a non-profit of the user's choice. Importantly, coins that are purchased or earned can only be gifted or donated by the user. These “purchased” digital coins are shown (or accumulated) in the user's profile (Note: for simplicity, the disclosure refers to both purchased and earned digital coins as “purchased digital coins”). On the other hand, digital coins that are received from other users can be exchanged for gift cards, debit cards or cryptocurrency. These “received” digital coins are shown (or accumulated) in the user's wallet. Although the terms “profile” and “wallet” are used for purposes of this disclosure, any terms can be used so long as the digital coins in each category—purchased or received—are only available for specific functions. Additionally, the digital coins (virtual currency) could be shown to the user in any part of the application—in other words, the digital coins are not required to be shown in the user's profile. The accumulated received digital coins in the user's wallet are maintained in a separate database than the accumulated purchased digital coins in the user's profile. This allows the system to permit one set of functions for the received digital coins and one set of functions for the purchased digital coins. The separate functionality of the received digital coins and purchased digital coins incentivizes users to give freely rather than simply earn digital coins and cash out. The user will feel the joy of giving and receiving.

The method includes the ability to aggregate and upvote kid-friendly positive content, such as video clips. The content creator, in this case the creator of a video clip, receives a prize if the creator's video clip receives the most votes during a certain set time frame. It is in this manner that high quality, kid-friendly content can be received by the users of the present system and method.

A flagging features may be used to identify traditional swear or curse words or overall negativity in the content of the social media post. The flag may prompt a pop-up box, requiring the user to review and rethink their post prior to sharing it. Additionally, the present invention may allow other users to report, delete or hide negative comments or posts of others from their own news feed, allowing a user to control his or her own social media experience and increasing overall positivity. If enough users in a user's own inner circle of friends report, delete or hide a post, that post will be deleted from the social media site as if it was never posted. The user who posted the reported post may be notified that their post was reported by the threshold number of users such that it was deemed negative and removed. Thereby providing feedback to the user that the post was interpreted negatively.

Therefore, the present invention provides a safer and more controlled social media platform for users. Moreover, the present invention gamifies the traditional social media experience, since a user may earn points, tokens, digital coins and/or rewards in response to participating in kind and positive actions. Finally, the present invention provides the user with a positive, more friendly experience on social media, by removing negative posts and incentivizing positive posts.

These and other features, aspects, and advantages of the present invention will become better understood with reference to the following description, appended claims, and accompanying drawings.

### BRIEF DESCRIPTION OF THE DRAWINGS

FIG. 1 is an exemplary depiction of a social media webpage, showing a prior art user interface on a social media website and/or application.

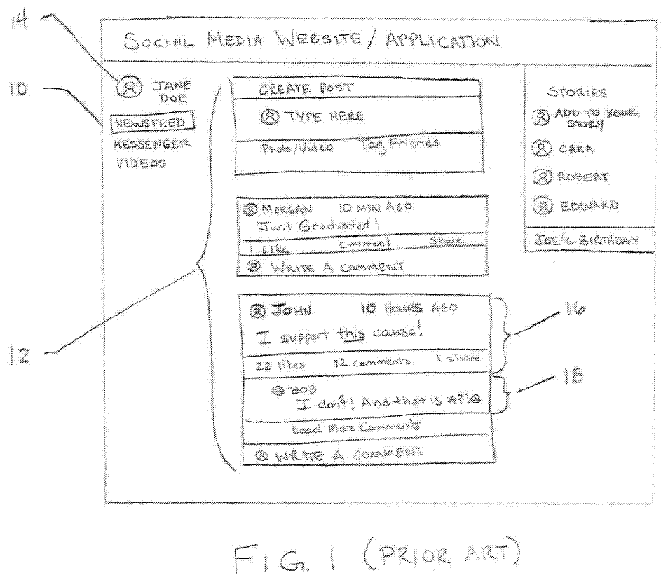

FIG. 2 is a flow chart, showing the step of the present invention.

FIG. 3 is a system diagram of the gamified social media system, in accordance with an embodiment of the invention.

FIG. 4 is a high-level conceptual diagram, showing actions that an end user can take in the present method.

FIG. 5 is a high-level conceptual diagram, showing the separation of the end user's wallet and profile.

FIG. 6 is a high-level conceptual diagram, showing how users can interact with challenges.

FIG. 7 is an high-level conceptual diagram, showing how users can share and fundraise for charities.

FIG. 8 is an exemplary user interface, showing the options for interacting with a video on the present system.

FIG. 9 is a high-level block diagram, showing the way a user can interact with video clips and how the system collects information on the interaction.

FIG. 10 is an exemplary user interface, showing how users can upload a video clip and interact with a video clip.

FIG. 11 is an exemplary user interface, showing a part of a profile page of the present invention.

FIG. 12 is an exemplary user interface, showing a video where the user can interact with the video.

FIG. 13 is an exemplary user interface, showing a screen where the user can search for challenges.

FIG. 14 is an exemplary user interface, showing a screen where a user can view or search for other users.

### REFERENCE NUMERALS IN THE DRAWINGS

10 prior art social media platform
12 prior art news feed
14 prior art user
16 prior art message
18 prior art negative message
20 method
22 first step
24 second step
26 third step
28 fourth step
30 fifth step
32 sixth step
34 end user
36 create story
38 perform challenge
40 create challenge
42 share challenge
44 celebrate others
46 nominate person or company
48 post tribute
50 create certificate
52 coin exchange
54 dashboard
56 leaderboard
58 challenges
60 subpage
62 activity feed
64 profile picture
66 glowing ring
68 point total
70 level
72 message
74 computing device
76 network
78 server
80 processor
82 database
84 home profile icon
86 vote icon
88 token icon
90 video clip (created on Awesome®)
92 video clip (linked from a third party platform)
94 creator icon
96 action icon
98 Awesome® icon
100 comment icon
102 share icon
104 challenge icon
106 award icon
108 add friend icon
110 video descriptors
112 search icon
114 back icon
116 notifications
118 settings icon
120 link to digital coins (e.g. Kindness Koin®)
122 user profiles
124 original video
126 shared video
128 shared video of shared video
130 charity wall
132 charity
134 more options icon
136 options
138 social media service
140 advertiser client
142 receiving digital coins
144 donate/gift digital coins
146 cash out received digital coins
148 view video
150 create video
152 share video
154 designate as fundraiser
156 profile
158 wallet

### DETAILED DESCRIPTION

Although reference is made to particular features of the invention throughout this disclosure, it is to be understood that the invention includes all possible combinations of the particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

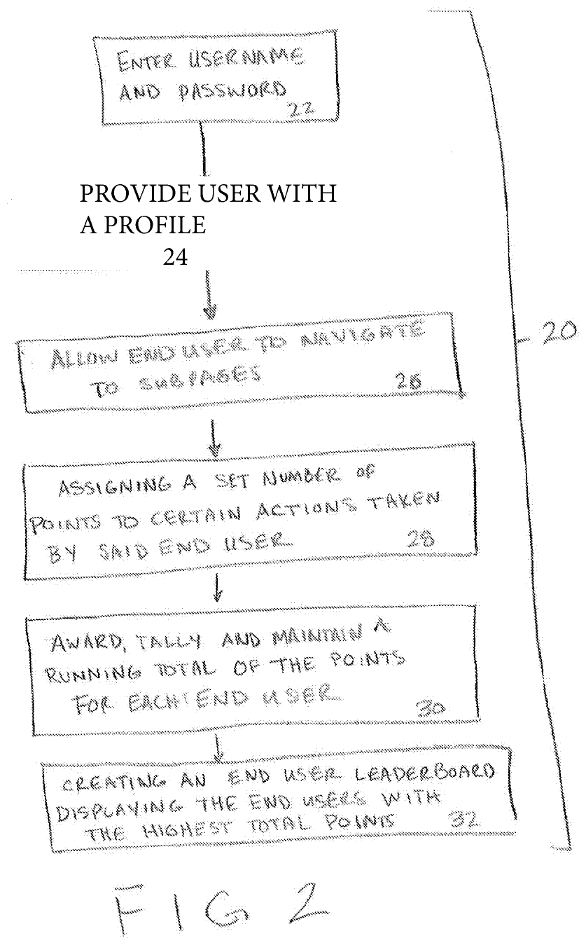

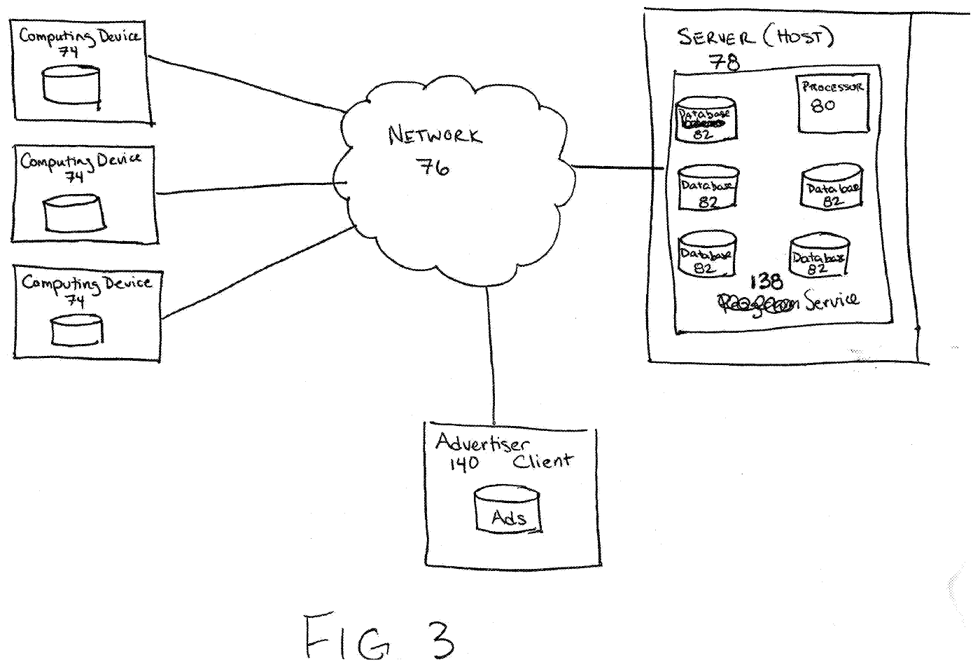

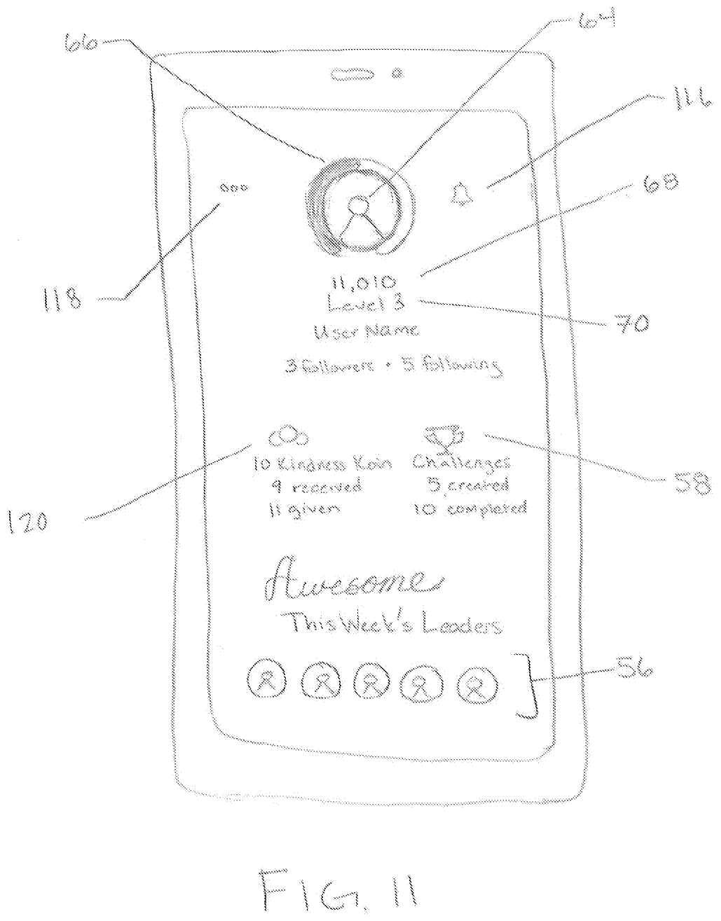

FIG. 2 is a flow chart showing a method of enabling and encouraging the end user to engage in positive actions using the present social network platform. The mobile application system (which, for purposes of this disclosures includes both the mobile application on a user's device and the platform or server that it communicates with—see FIG. 3) allows a user to create a username and password. Thus, the first step 22 of one embodiment of the method is entering (or creating) the username and password to log on to the user's account. The second step 24 is providing the user with a profile (see FIG. 11), wherein the profile displays information that highlights a series of information. The user is initially brought to either their profile page or directly to a video feed. The user can interact with the video or swipe up on the video to watch a new video. The video content is preferably short video clips. The user can also navigate to the user's profile and from there to other subpages. Therefore, the third step 26 of the method is allowing the end user to navigate to the particular subpage by providing the subpages and functionality of each element. The fourth step 28 is assigning (or allowing for the assignment of) a set number of points to certain actions on the social media platform. The application system, in the fifth step 30, awards, tallies and maintains a running total of the points for each end user. An end user may, for example, engage in a challenge that defines a kind action in exchange for a set number of points. When the user completes the action (by physically completing the task and clicking “complete” or similar icon on the challenge subpage) he or she will be awarded the set number of points defined for that specific challenge. The earned points will be added to the point total for that user. In the sixth step 32, the application system creates an end user leaderboard, displaying the users with the highest point totals as “leaders” in kindness. The leaderboard is composed of users across the social media platform that have earned the most points by engaging in positive behavior and challenges. Points can be earned for a number of different actions on the social media platform as further described herein. Although these steps are described in a chronological order, they do not have to be performed in the set order. For example, an end user may sign on to the application and immediately view the leaderboard to view the “leaders” in kindness without participating or earning points first.

FIG. 3 is a high-level block diagram illustrating the interaction of hardware that the present system and method is operable on to engage with the social media service and system. The system environment includes a series of computing devices 74 (user devices/user client) that can access a network 76 to call server 78. The user devices 74 (user client) may be any computing device, but the present description is directed to smart mobile phone devices. The devices can communicate via network 76, which can be any combination of local area and/or wide area networks, using both wired and wireless communication systems. An application on the user device 74 communicates with a social media service 138 located on a server 78. Server 78 holds a processor 80 and a series of databases 82. The databases 82 allow information and data to be stored relating to all aspects of the social media service 138—included uploaded information, usernames, passwords, video content, profiles, wallet, charity pages/profile, challenges, etc. An advertiser client 140 also communicates through network 76 with server 78.

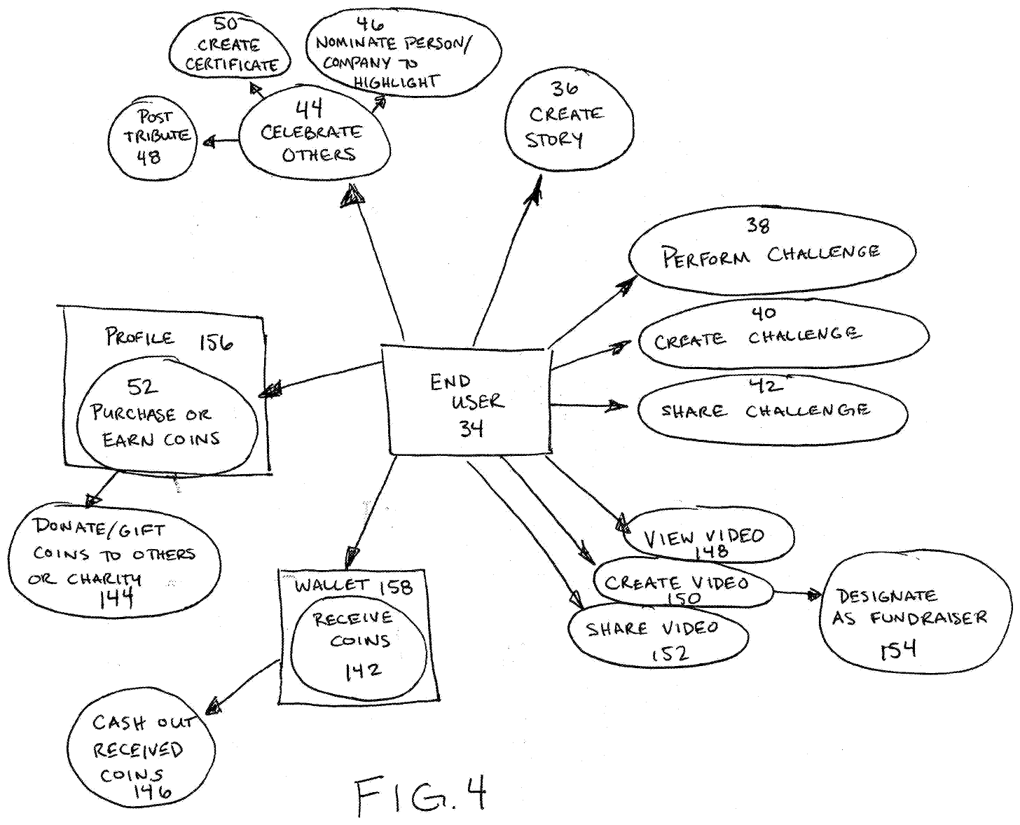

FIG. 4 is a high-level conceptual diagram illustrating the actions that an end user 34 can take when he or she signs on to use the present system. When an end user 34 signs on through his or her mobile device via the present mobile application system, the user will be presented with either their profile or a video feed. The end user 34 can navigate to subpages which contain greater detail for each element. FIG. 4 illustrates that the end user 34 can opt to engage in the application system by creating a story 36, performing, creating or sharing a challenge 38, 40 and 42 respectively, celebrating others 44, purchasing or earning digital coins 52 (also known as Kindess Koins®), receiving digital coins 142, viewing 148, creating 150 or sharing 152 videos and designating a video 154 as a fundraiser to benefit a charity by tagging a charity wall.

The reader will appreciate that these actions can represent additional steps in the current method and system. In one example, an end user 34 can create a story 36 by uploading images or videos or simply typing text into a window that accepts the content and displays the content for a set period (e.g. 24 hours). The system encourages the end user 34 to enter content that is inspirational to themselves or others (e.g. “Have an Awesome Day!” “You got this!”). This content can then be viewed by the end user 34 themselves or others to feel encouraged and inspired.

The end user 34 can also engage in challenges, described further herein. The challenges can be created, shared or performed for points or other rewards. Third party companies can post challenges and provide rewards. For example, a local coffee shop could create a challenge to buy a stranger a cup of coffee and provide a discount to the coffee shop upon completion of the challenge. Additionally, a user can celebrate others 44. The user can celebrate others 44 by posting a tribute to an individual 48, creating a certificate 50 for another user or nominating a person or company to highlight on a “wall of fame” 46 within the application. These celebrations may be monetized, allowing a user to post a tribute, create a certificate or nominate an entity or individual by engaging in an in-app purchase. For example, if a user opts to create a certificate, they will purchase the certificate, complete a provided template and “give” the certificate to another user letting that user know that they are appreciated and acknowledging that user's achievements. The certificate can be shared with the recipient in any known manner. For example, the recipient could receive the email in an email. The certificate may be made public or private on the receiving user's profile.

The user can also view videos 148. The video content is curated by the administrator for positivity. Additionally, users can monitor and report content that is negative or inappropriate. A user can interact with a video. For example, the user could donate digital coins to the video creator or to the charity that the creator designated for the specific video. The user can share a video 152, which allows a specific video to reach a broader audience of users. If a shared video has a designated charity, all donations will reach that charity, as described further herein. Note that challenges can be videos, but they are not required to be videos, nor are all videos required to be challenges. The reader will appreciate that although several elements are described herein, this list of elements is not exhaustive.

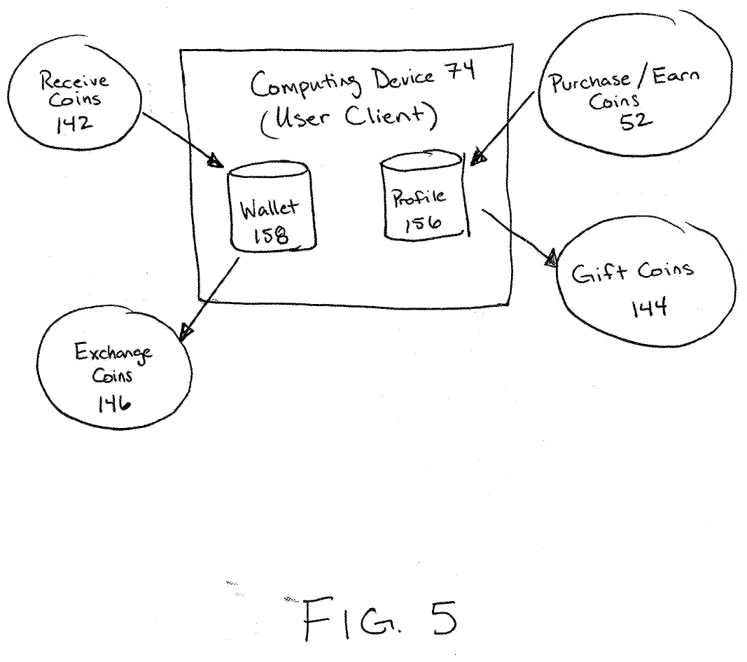

FIG. 5 is a block diagram that generally shows how the user receives, exchanges, earns, and gifts digital coins. The present system provides a user interface that includes a wallet 158 and profile 156. These elements function by allowing a user to view, receive, purchase/earn, exchange and gift digital coins. Importantly, when a user purchases or earns digital coins 52, the user can only donate or gift those digital coins to other users or charities through the present system. These purchased or earned digital coins 52 appear in the user's profile 156. Digital coins or tokens, having a set value (e.g. 5 cents) can be purchased in bundles, earned by spending time on the mobile application, watching an advertisement or by inviting friends to the application. The administrator of the mobile application shares in ad revenues by allowing users to earn digital coins. The manner in which digital coins can be earned through the present system should not be limited by the examples provided. The user can gift or donate digital coins from their profile 156 directly through the present system. If the user wishes to donate digital coins to a charity, the user can do so by simply directing the donation to the administratively created charity subpage within the present system. If the user wishes to gift a digital coin, or multiple digital coins (e.g. 1, 20, 100, 1,000 digital coins) to another user, they can do so through the present system. The receiving user will receive the digital coins and experience a certain graphical display based on how many digital coins were received. For example, if the user receives 20 digital coins the user may see digital coins “raining” down on their user profile page. The user will then see those digital coins in a separate area of the screen than the digital coins they have earned or purchased.

If the user receives digital coins into their wallet 158, the user can exchange (or cash out) those received digital coins 146. These received digital coins appear in the user's wallet 158 (Note: the wallet 158 and profile 156 digital coins can be displayed on the same subpage in the system, such as in the user's profile—however the separate values would be in different areas of the page). A user can receive digital coins from other users. The user can exchange received digital coins in their wallet 158 by opting to receive a gift card, cryptocurrency, or a debit card (or any other known method of cashing out digital coins).

The clear separation of the user's wallet 158 and profile 156 discourages users from simply collecting purchased or earned digital coins for themselves. Often an individual feels joy when giving to others, but it is difficult to do so if the individual has the option of exchanging the value of earned digital coins for themselves. The present system and method harnesses technology to allow users to help and reward others, by only permitting earned or purchased digital coins to be gifted to others for value. The bifurcation of the wallet 158 and the profile 156 encourages kindness, positivity and gratitude.

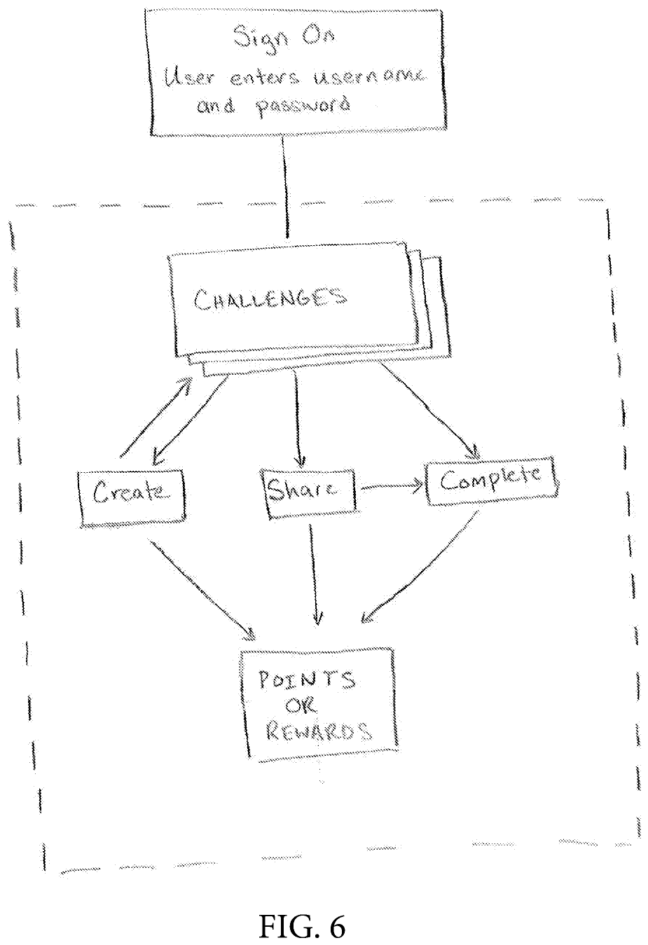

The present method is designed to increase kindness and positivity not only within the social media platform as described above, but also in user's everyday life. Therefore, the application allows users to engage in challenges, shown in a high-level conceptual diagram in FIG. 6. After a user signs on and enters their username and password, the user gains access to the dashboard which includes a challenge tile wall. The challenges are accessible to the end user by viewing the tiles that include a short summary of each challenge and/or clicking on a challenge to provide the end user with greater details relating to the challenge. The reader will appreciate that in one embodiment the method would allow the user to tag certain challenges of interest to allow the user to come back to the challenges to select from a smaller curated number of challenges. Additionally, the method may allow a user to tag challenges for their in-app friends. As illustrated in FIG. 6, the challenges can be created, shared or completed by an end user. Upon any one of these actions (create, share or complete) the method awards the end user with a set number of points that are aggregated in the user's point total.

A kindness challenge is specifically designed to engage end users from across the platform to participate in kind acts toward others. The challenges can be simple or complex, easy, or difficult and as creative as the individual or third-party entity wishes to make it—so long as it is kind. Challenges do not necessarily have to be created by end users, but instead can be pre-loaded by the developers for end users to participate in or created by third-party companies. If a challenge is created by an end user, the end user has a simple template to complete including, but not limited to, a set description, an image or video and a set number of points (points may be set by the user within a range of points or the points may be pre-designated for particular challenges). An example of a complex challenge may be to adopt a pet, while another simpler challenge may simply be to say “hi” to ten neighbors in 24 hours. Each challenge is assigned a set number of points that the end user 34 can view prior to choosing to participate in the challenge. Upon completion of the challenge, the end user may record the challenge complete by clicking a “completed” icon or otherwise recording the completion of the challenge. In one embodiment, a user may be required to take a picture or record the act in some manner. For example, if a third-party company creates a challenge, the company may require the user to take a picture of a receipt or describe their action to receive a reward, such as a coupon or free gift. A user can also share and comment on challenges. This allows a user to post challenges to his or her activity feed and allows friends to comment on those challenges. A user is incentivized to complete as many challenges as possible to continue earning points and leveling up in the community.

However, points are not the only rewards that a user or third-party can designate for the completion of certain challenges. For example, a third-party business or other end user may reward an end user with a coupon, discount, free gift or digital coins (Kindness Koins®) for completing a challenge.

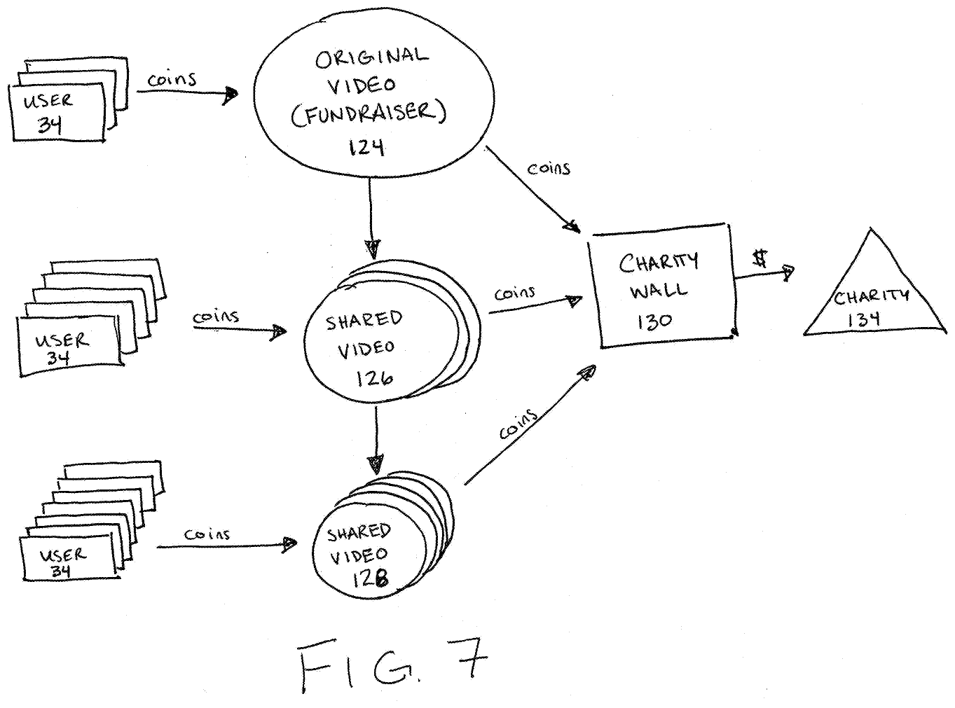

FIG. 7 show a series of screenshots illustrating the present system in use. FIG. 5 shows a screenshot a typical dashboard 54 that the user interacts with upon first opening the application. The dashboard 54 displays the top leaders of each week for each user in leaderboard 56. The user may view the leaderboard, which may be composed of users across the platform that have earned the most points for engaging in positive behavior and actions. By clicking on the leaderboard, the user can view a full list of point leaders or a more defined list (e.g. user's friend circle) of users and their respective points. The user can navigate to the profile page of the leaders listed on the leaderboard. However, note that the present system may provide the option for maintaining privacy and/or making a profile or account private and only accessible to select users that the end user designates. If a leader's profile is public or accessible to the end user, the user can view that leader's completed challenges, activity feed, level, etc.

A user can also view the tile wall of positivity challenges 58 on the dashboard. Positivity or kindness challenges 58, as described above, are various challenges that a user can participate in to perform kind acts and receive a reward. If a user chooses to participate in the challenge, he or she will earn more points and possibly other incentives. The more points a user earns, the more likely he or she is to place in leadership board 56. As the user accumulates points the user moves on to higher levels (“level up”). The level is displayed below a user's profile picture as shown in FIG. 11.

FIG. 7 is a high-level block diagram showing the ability of the system to increase the reach and ease of donating to a charity or a cause. The reader will appreciate that while the term charity is used, it should not be limited to a non-profit organization. Charity, in the context of this disclosure, could also be for the benefit of an individual, business or a particular cause. The present diagram starts with a user 34 posting an original video 124 and designating the video as a fundraiser. To designate the video as a fundraiser user 34 identifies a charity wall 130 to benefit if digital coins are given to the video. In other words, in preparing the video for posting to the system, the user 34 edits the video and then previews the video. In the preview screen, user 34 has the option to title the video (or challenge), describe the video (or challenge) and add hashtags to the video. Additionally, user 34 can determine whether they want all videos that join the challenge to use the original audio. Finally, user 34 can designate whether they want the donated/gifted digital coins (Kindness Koins®) to come to their profile or not. If they do not want the digital coins to come to their profile, they can designate a charity 134 to benefit. The system includes charity walls 130 that identify and describe charities. Once the video is designated as a fundraiser, all digital coins donated as a result of the video will be collected for the charity 134. The system will keep track of the donated coins in a database and will maintain the identification of the charity that the digital coins are donated on behalf of. The unique method provides two important benefits. First, if a video is shared, the designation automatically follows the video. Second, users can donate through the application without re-entering payment information for each donation or gift.

Both advantages of the present system and method are illustrated in FIG. 7. As previously described user 34 creates an original video 124 and designates it as a fundraiser. When other users view the original video 124, users have the option to donate digital coins. The digital coins are “passed through” the video and linked to the charity wall 130. In other words, the system keeps track of the number of collected digital coins given to that charity 134 for that video. If the original video is shared by another user 126, to promote the fundraiser, other users can donate to the shared video, in the same manner they could donate to the original video. Importantly, the user sharing the video has no other option but to maintain the designation from the original video 124 that all digital coins donated are directed to the designated charity 134. Therefore, as users view and donate to the shared video 126, the digital coins continue to be collected in connection with the charity wall 130 of the original user's choosing. This allows the original video 124 to reach more users. The shared video 126 can be shared again, sharing the shared video 128. Again, the copy of the copy must maintain the original designation of the original video 124 of how the digital coins are directed. The original video 124 can be promoted any number of times by any number of viewers but it never loses the designation that donated digital coins are directed to the specific challenge. When the digital coins are donated, the users simply click an icon while watching the video and selects how many digital coins to donate. The digital coins are directed to the charity wall 130 that is created within the system that identifies a particular charity 134. The charity walls 130 make it simple for a user 34 to donate directly within the application (present system) without leaving the application. Typically, to donate to an organization the user would be required to click on a link and input payment information after leaving the application. The present method allows users 34 to donate already purchased or earned digital coins within the application (from their profile). This enables them to donate to the video by one or two clicks and continue scrolling through videos.

The present method also allows users to join challenges by creating their own videos within the same originally posted challenge. The user originally creating the challenge can designate the challenge as a fundraiser for a particular charity 134 and the challenge can work in the same way as FIG. 7 illustrates for sharing an original video. Joining the challenge in this manner would be akin to sharing the video, for purposes of FIG. 7. Note that when the original user creates the challenge, they would not be required to designate a charity. Instead, they could allow other users to join the challenge without benefiting any charity or allow other users to designate a different charity to benefit.

FIG. 7 is a screen shot illustrating the user interface of subpage 60 showing a layout for an end user to interact with by searching for challenges, users or other information. A user can search for a positive activity he or she is interested in pursuing. For example, as shown in the FIG., a user could use the search bar incorporated to search for “charity” to find a positivity challenge 58 that involve a charity, are sponsored by a charity, and/or involves charity work. The menu may also display the user's friends, which are the user's inner circle of people that he or she has chosen to follow or be friends with on gamified social media. The user can also navigate to their friend's activity feed or profile to view what challenges their friends are participating in, sharing or completing.

Further, the subpage also displays various positivity challenges 58 that a user may choose to engage in. For example, one positivity challenge displayed in FIG. 7 asks users to “send flowers to a patient.” In exchange for completing this action, and thus spreading positivity, the user can earn points. The points a user earns may be used to fund a user's own positivity challenge, and/or to redeem tokens, as discussed below.

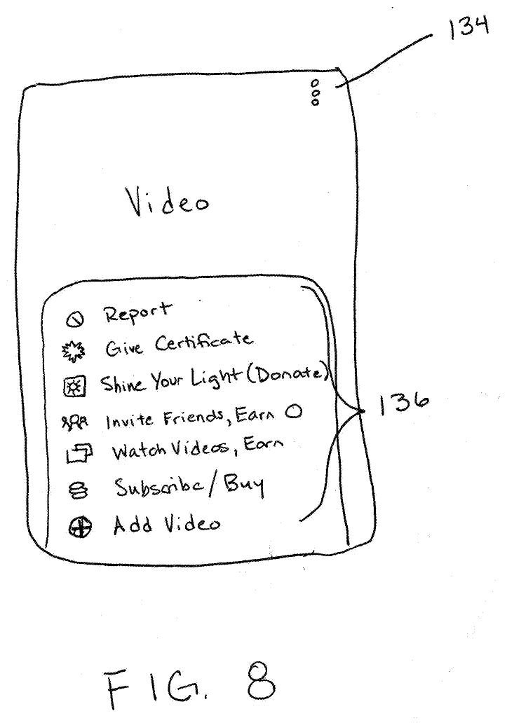

FIG. 8 is a screen shot that displays a banner that slides up from the bottom of a video that allows a user to interact with the video that they are presently watching. The videos are typically short in length—shorter than 3 minutes. After or during the video, the user can click on the more options icon 134, which pulls up a banner at the bottom of the screen, as shown. The banner provides the user with multiple options 136. The user can report the content as against the applications policies. This gets reported to the administrator for review. The user can give a certificate, which shows up in the user's profile who uploaded the video to the system. The user can donate or give digital coins by clicking on “Shine Your Light”. The user can invite friends, watch videos or subscribe/buy digital coins to accumulate digital coins in their profile to give to others. And the user can add a video. Although multiple options are shown, the system is not limited to these options. However, it is important to note that the ease of giving digital coins to a video without leaving the video feed is important to users who want to stay on the application and continue to scroll through videos.

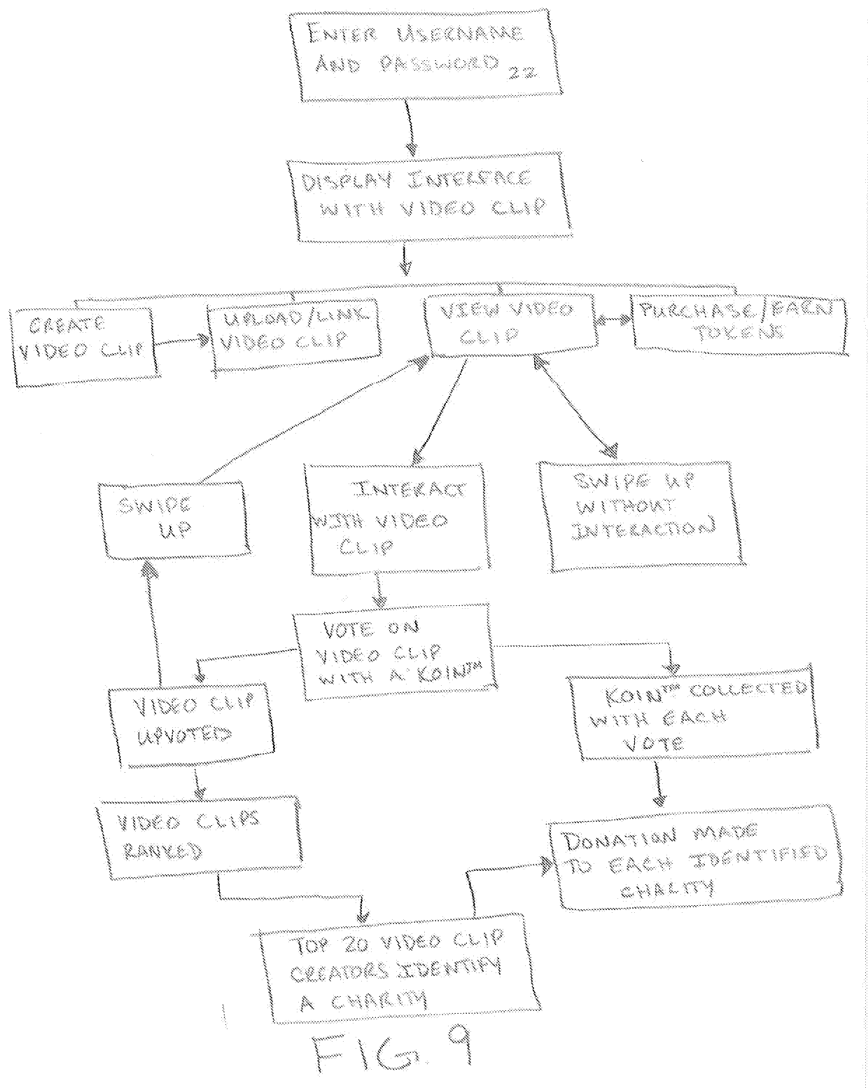

As previously discussed a user can purchase, share, donate or receive Kindness Koins®, referred to as digital coins above. These “Koins” can be purchased in-app (in bundles, e.g.), earned by completing challenges or received by a gift from another user. The digital coins have a real set value, so when the user receives digital coins as a gift and the digital coins are accumulated in the user's wallet, the user can redeem the digital coins for gift cards, debit cards or for cryptocurrency. The use of digital coins may include a collaboration with a company who chooses to partake in a gift or discount redemption in exchange for being featured on the application. The digital coins can be earned in the user's profile by viewing rewarded advertisements or by inviting friends to the application. These digital coins can be used to vote on positive video clips, as described in FIG. 9. Finally, the digital coins and platform itself can be used for fundraising. For example, a user can start a micro-fundraiser by posting a video requesting digital coins. As one example, a teacher in need of help raising funds for classroom supplies could create a video and receive Kindness Koins®, which can be redeemed for value. A second user can share that video clip to assist in helping to raise the necessary funding, while the application directs the digital coins to the original content creator, as discussed in relating to FIG. 7—however here the original user receives all digital coins rather than the charity. Additionally, users can invite charities and non-profits to share videos to receive digital coins redeemed for value in the form of gift cards or cash/credit via PayPal®.

There are also “free tokens” or “certificates” which do not have a set value, in which one user can share positivity with another user. These free tokens may be for “love,” “hugs,” “happy birthday,” “in memory of,” etc. The user sending the free token may fill the token with points they have earned or purchased and send those points to another user with the free token.

The present system and method also includes a flagging ability. Since gamified social media is tailored towards enhancing positivity, a user can flag, delete negative comments or posts of others. For example, if a user's friend posts a negative text post, the user will be able to hide said post from his or her activity feed so that it will not show up again. If enough users flag or delete the same post, the post will become deleted by the present system and method, as if it was never posted. The user may be notified that the post was deemed negative to provide feedback to the user. This available feature promotes positivity and eliminates negativity, which is one primary goal of the system.

Finally, the present method may include an optional pop-up ability to ensure that users re-think posting negative posts. Specifically, prior to a user attempting to post a text, the post may be flagged by the system as containing swear words and/or flagrant language. The user will be presented with a pop-up window that will ask the user to reassess the language of their post. While the system allows the user to still post the comment, the pop-up encourages the user to re-think any negative post to enhance positivity.

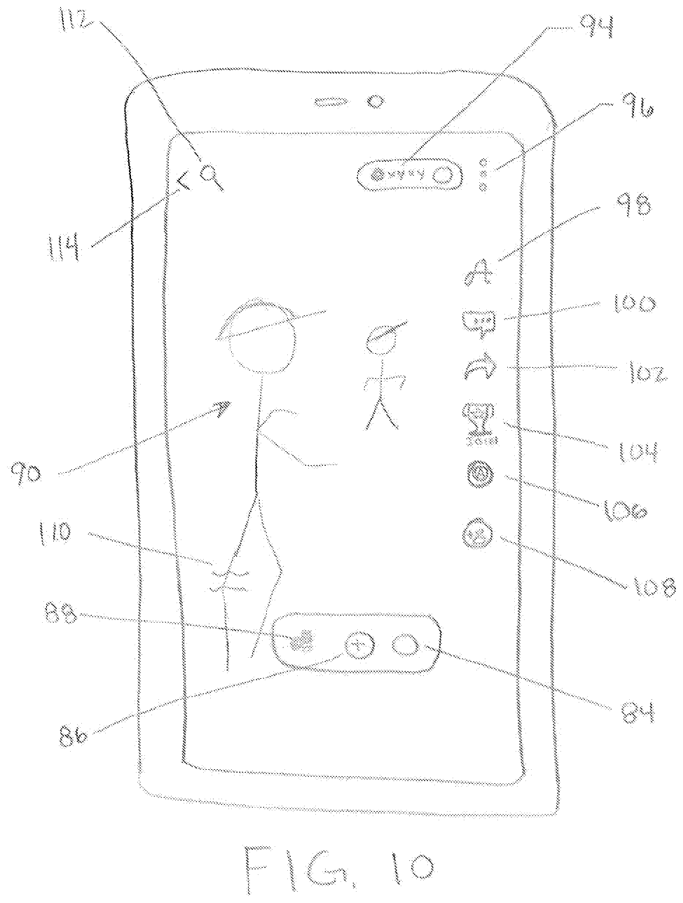

FIG. 9 is a flow chart showing a second embodiment of the method of enabling and encouraging the end user to engage in positive actions by aggregating and upvoting positive content using the present social network platform. It is in this manner that the present system can aggregate positive content from third party applications to encourage kindness and positivity. The mobile application system (which, for purposes of this disclosures includes both the mobile application on a user's device and the platform or server that it communicates with—see FIG. 3) allows a user to create a username and password. Thus, the first step 22 of the present method is entering (or creating) the username and password to log on to the user's account. The reader will appreciate that the system or mobile device can store a username and password so that the user is able to simply open the application and automatically achieve the step of “signing in.” The second step 24 is providing the user with a user interface (see FIG. 10), wherein the user interface displays a video clip. The user has the option to navigate away from the video clip or view the video clip. For example, as shown in FIG. 10, when watching a video clip 90, the user can navigate to that user's profile by selecting the home profile icon 84.

FIG. 11 illustrates the user interface that is displayed when the home profile icon 84 is selected. A user profile picture 64 is shown inside of ring 66 which can glow or react as the user gains point, thereby getting closer to or levelling up. Points 68 are preferably displayed under the user's profile. In this FIG., the user has 1400 points and the glowing ring 66 is about two-thirds illuminated. As the user earns more points, the glowing ring 66 will eventually completely “fill in” the arc or circle, signaling that the user has achieved a higher level 70. The ring 66 will begin to fill again at the start of a new level. The user can select a message 72 to display on the profile page. The message 72 can be a positive or inspirational message for all to view. A notification icon 116 can be selected to see any user notifications, such as if the user has received tokens, Kindness Koins®, votes, messages or any other notification. A settings icon 118 is shown to the left of the user profile picture 64 as three small dots. The user can select this icon to gain access to the terms of use, privacy policy, customer support and/or profile changes, such as deleting a profile. Also displayed is the user's point total 68, level 70, username, and follower/following count. The point total leaders 56 are shown at the bottom of the profile page. Finally, the user's Kindness Koin® count and challenges count are displayed. The Kindness Koin® icon 120 can be selected to purchase, earn, give and/or view Kindness Koins® that have been given or received. The challenges icon 58 can be selected to create and/or view challenges that have been completed or created by the user.

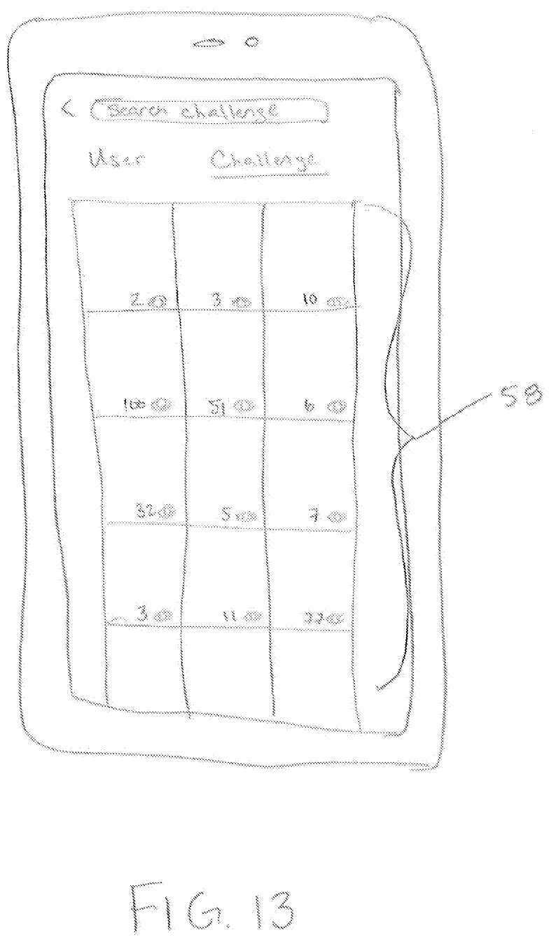

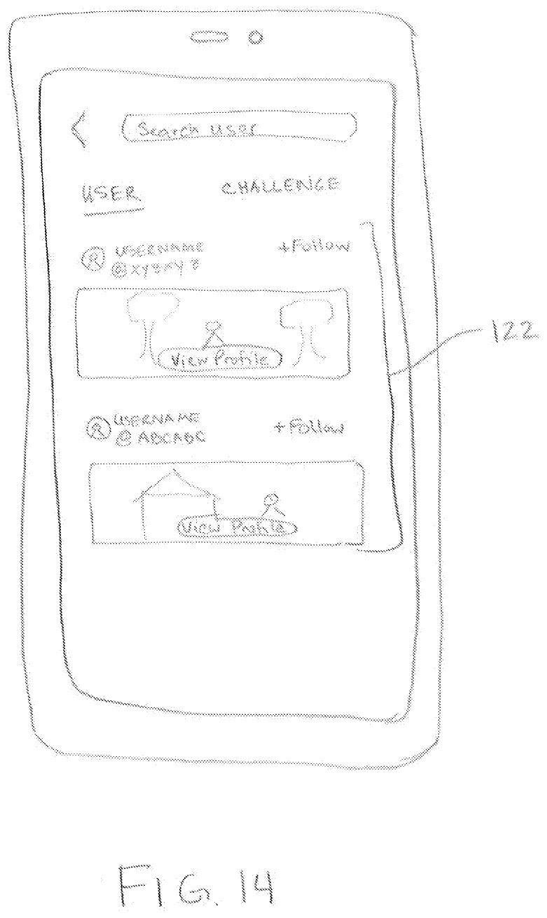

Returning to FIG. 10, in the instance where a video clip 90 is created on the Awesome® platform (as opposed to a third-party platform), a user can also elect to view a number of other icons. For example, the user can view the creator's profile 94 or add/follow the creator of the video clip 108. An action icon 96 allows the user to block content, report a user, hide content, give digital coins and/or give a certificate, as illustrated in FIG. 8. An Awesome® icon 98 allows a user to like the video, the challenge icon 104 allows a user to join a challenge (saving that challenge to the user's “challenge” count and subpage found by selected the user's home profile icon 84 and navigating to challenges). Other icons include a share icon 102, comment icon 100, certificate icon 106 and a back icon 114. The search icon 112 at the top of the page, takes the user to a page where the user can search user profiles, as shown in FIG. 14, or challenges 58, as shown in FIG. 13. It is in this manner that a user can obtain easy access to challenges in certain topic areas or those created by a specific user.

Returning to the present method depicted in FIG. 9, the reader will appreciate that although a user may create and upload video clips (challenges), many users will continue to view and interact with video clips. In the present method, the system preferably displays two (2) third party platform video clips 92 and one (1) video clip created on the Awesome® app 90. As the user views the video clip, the user can cycle through the clips by either interacting with the video clip or swiping up without interaction. When a user chooses to interact with the video clip, the user can “vote” on the video clip by giving a Koin using the vote icon 86. That video clip will be “upvoted.” The user can then swipe up to view the next video clip. When a video clip receives a Koin, the Koin is collected and aggregated by the app. At the end of the specific period of time (e.g. at the end of the year) the votes will be tallied, and the video clips will be ranked. The top 20 video clip creators will be provided the opportunity to identify a charity (in some cases, a charity directed to children). The aggregated digital coin value will be divided equally and donated to each identified charity. The cycle of kindness is reinforced because the user is encouraged to vote to benefit charity and the creator is encouraged to create kind and inspiring content to receive votes to direct money to charity.

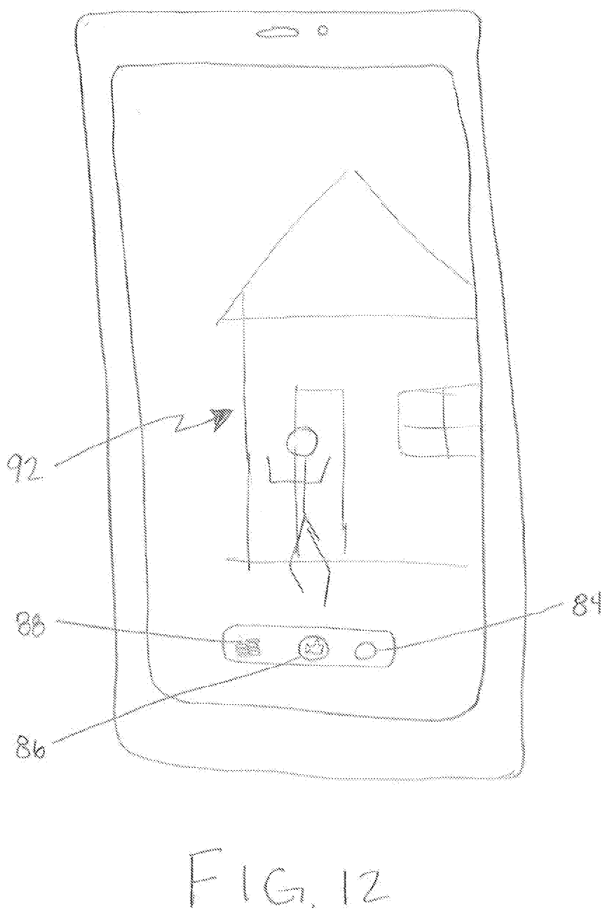

The user can interact with the video clip created on the Awesome® application 90 in more ways that the user can interact with the video clips linked from third party platforms 92. As shown in FIG. 12, the video clip linked from a third-party platform 92 simply allows the user to select the vote icon 86 to interact (the Kindness Koin® icon 88 allows for the purchase of Kindness Koins® while the profile icon 84 takes the user to their profile). On the other hand, as previously described, the video clips created on the Awesome® application 90 shown in FIG. 10, allow for additional interaction (such as giving a certificate, joining a challenge, adding a creator, etc.).

The features described are preferred due to their advantages over the prior art but are not required in all embodiments of the invention. Importantly, the invention does not require that all features described herein be incorporate into every embodiment of the invention.

The preceding description contains significant detail regarding the novel aspects of the present invention. It should not be construed, however, as limiting the scope of the invention but rather as providing illustrations of the preferred embodiments of the invention.

Having described my invention, I claim:

1. A method and system implemented on a computer, comprising:
providing content on an application graphical user interface to a user over said network, said content being displayed to said user on a computing device;
providing a digital coin within said application, having a set value;
allowing said user to earn and purchase a plurality of digital coins in a profile, wherein said plurality of digital coins are earned by performing an action;
allowing said user to receive a plurality of digital coins in a wallet from other users;
permitting said user to exchange said plurality of digital coins in said wallet for a value that corresponds to said set value of said plurality of digital coins combined;
permitting said user to donate said plurality of digital coins in said profile to other users and a plurality of charities; and
preventing said user from exchanging said plurality of digital coins in said profile for value.

2. The method and system as recited in claim 1, wherein said content is a series of short video clips.

3. The method and system as recited in claim 2, wherein said action performed by a user is interacting with a set number of said short video clips.

4. The method and system as recited in claim 1, wherein said action performed by a user is remaining active on said application for a set period of time.

5. The method and system as recited in claim 2, further comprising the steps of:
allowing said user to designate a short video clip as a fundraiser for a specific charity by selecting a corresponding charity wall;
linking said short video clip to said charity wall of said charity such that said designation by said user directs said digital coins donated by said plurality of users to a database wherein said application keeps track of said donated digital coins;
allowing said plurality of users to interact with said short video clip by electing to donate at least one digital coin; and
directing all of said at least one digital coins to said charity wall linked with said short video clip as designated.

6. The method and system as recited in claim 5, further comprising the step of allowing said plurality of users to share said short video clip while preventing said plurality of said users to remove said designation of said digital coins to said charity wall.

7. The method and system as recited in claim 6, wherein said charity wall includes information about a specific charity.

8. The method and system as recited in claim 1, wherein said step of exchanging said plurality of digital coins, includes trading said plurality of digital coins for a gift card.

9. The method and system as recited in claim 1, wherein said step of exchanging said plurality of digital coins, includes trading said plurality of digital coins for an amount of cryptocurrency.

10. The method and system as recited in claim 1, wherein said step of exchanging said plurality of digital coins, includes trading said plurality of digital coins for a debit card.

11. A method and system allowing a user to engage in gamified social media over a network comprising the steps of:
providing a computing device having an application for a plurality of users wherein said application is configured to display content on a graphical user interface, wherein said content is a series of videos and a subpage having a user profile;
providing a digital coin having a set value;
allowing said plurality of users to accumulate said digital coins by purchasing said digital coins and earning said digital coins by performing an action;
designating said digital coins earned or purchased as an amount of purchased digital coin;
allowing said plurality of users to receive said digital coins from other users;
designating said digital coins received as an amount of received digital coin;
providing each of said plurality of users with a running tally of said amount of purchased digital coins and a separate running tally of said amount of received digital coins;
allowing said plurality of said users to give said purchased digital coins to other users;
allowing said plurality of users to exchange said received digital coins for value; and
preventing said plurality of users from exchanging said amount of purchased digital coins.

12. The method and system as recited in claim 11, wherein said content is a series of video clips that are short in length.

13. The method and system as recited in claim 12, wherein said action performed by a user is interacting with a set number of said video clips.

14. The method and system as recited in claim 11, wherein said action performed by a user is remaining active on said application for a set period of time.

15. The method and system as recited in claim 12, further comprising the steps of:
allowing said user to designate a video clip as a fundraiser for a specific charity by selecting a corresponding charity wall;
linking said short video clip to said charity wall of said charity such that said designation by said user directs said digital coins donated by said plurality of users to a database wherein said application keeps track of said donated digital coins;
allowing said plurality of users to interact with said short video clip by electing to donate at least one purchased digital coin; and
directing all of said at least one purchased digital coins to said charity wall linked with said video clip as designated.

16. The method and system as recited in claim 15, further comprising the step of allowing said plurality of users to share said video clip while preventing said plurality of said users to remove said designation of said digital coins to said charity wall.

17. The method and system as recited in claim 16, wherein said charity wall includes information about a specific charity.

18. The method and system as recited in claim 1, wherein said step of exchanging said plurality of received digital coins, includes trading said plurality of received digital coins for a gift card.

19. The method and system as recited in claim 11, wherein said step of exchanging said plurality of received digital coins, includes trading said plurality of received digital coins for an amount of cryptocurrency.

20. The method and system as recited in claim 11, wherein said step of exchanging said plurality of received digital coins, includes trading said plurality of received digital coins for a debit card.
